(19) United States
(12) Patent Application Publication
(10) Pub. No.: US 2019/0207434 A1
(43) Pub. Date: Jul. 4, 2019

(54) ELECTRICITY STORAGE DEVICE

(71) Applicant: XIU XIU TECHNOLOGY (SHENZHEN) CO., LTD., Shenzhen, Guangdong (CN)

(72) Inventor: Zhengjun ZENG, Shenzhen, Guangdong (CN)

(21) Appl. No.: 15/754,185

(22) PCT Filed: Dec. 29, 2017
(86) PCT No.: PCT/CN2017/120256

§ 371 Date: Feb. 21, 2018

(51) Int. Cl. H02J 50/80; H02J 5/00; H02J 50/10; H02J 7/02; H04B 1/3883

(52) U.S. Cl. CPC H02J 50/80; H02J 5/005; H04B 1/3883; H02J 7/025; H02J 50/10

(57) ABSTRACT

An electricity storage device comprising a battery case in which an electric energy storage component, an electric energy transmitting component, an electric energy receiving component and a power adaptation component are arranged; the electric energy storage component wirelessly receives external electric energy through the electric energy receiving component and stores the electric energy; the electric energy transmitting component wirelessly transmits the electric energy stored in the electric energy storage component to an electronic device to be charged, a wireless transmission component and a data storage component are further disposed in the battery case, the wireless transmission component inputs wirelessly received data into the data storage component and wirelessly outputs the data stored by the data storage component to the electronic device.

### TECHNICAL FIELD

The present application relates to the technical field of charging, and more particularly relates to an electricity storage device.

### BACKGROUND

People have increasing demands on battery life of mobile electronic devices such as mobiles phones and tablet PCs. However, manufacturers are limited to taking into account the volume and weight of mobile electronic devices, and the battery life of mobile electronic devices that are often made cannot meet user needs. As a result, there is a mobile power supply that can charge mobile electronic devices anytime and anywhere in the market, but the mobile power supply today needs to connect the cable in the case of charging and discharging. If the user carries a mobile power supply without a cable, then the user may cannot charge the mobile charge supply itself and mobile electronic devices as well. Moreover, the function of the mobile power supply today lacks diversity, and the user will encounter the following problems when using electronic devices: a large number of files, such as pictures and music, are stored in electronic devices, and the total size of the files to be stored tends to exceed the available storage capacity of electronic devices, in that event, only when the original files are deleted, more files can be stored, this may cause inconvenience to the user.

### SUMMARY

One object of the embodiments according to the present application is to provide an electricity storage device, which solves the problem of the prior art that the charging of the electronic devices is inconvenient and the storage capacity of the electronic devices is excessively small.

In order to solve the aforementioned problems, the embodiments according to the present application provide an electricity storage device as follows.

The electricity storage device includes a battery case in which an electric energy storage component, an electric energy transmitting component, an electric energy receiving component and a power adaptation component are arranged; the electric energy storage component is connected with the electric energy receiving component and wirelessly receives external electric energy through the electric energy receiving component and stores the electric energy; the power adaptation component is connected with the electric energy receiving component and configured to convert the alternating current through the electric energy receiving component into a direct current and to store the current in the electric energy storage component; the electric energy transmitting component is connected with the electric energy storage component and wirelessly transmits the electric energy stored in the electric energy storage component to an electronic device that is expected to be charged;

the battery case is further provided therein a wireless transmission component and a data storage component, wherein the wireless transmission component is connected with the electric energy storage component which provides electricity for the wireless transmission component, the wireless transmission component is configured to be connected with the data storage component and to input wirelessly received data into the data storage component and to wirelessly output the data stored by the data storage component to the electronic device.

According to an aspect of the present application, the wireless transmission component is a Wi-Fi component, the electricity storage device can wirelessly receive data of the electronic device through the Wi-Fi component and transmit the data to the data storage component, and wirelessly output the data stored in the data storage component to the electronic device.

According to an aspect of the present application, the wireless transmission component is a Bluetooth component, the electricity storage device can wirelessly receive data of the electronic device through the Bluetooth component and transmit the data to the data storage component, and wirelessly output the data stored in the data storage component to the electronic device.

According to an aspect of the present application, a detection component is further arranged inside the battery case, wherein the detection component is connected respectively with the electric energy storage component and the electric energy transmitting component, and the detection component includes a power detection module, a connection state detection module and a charging time detection module, the power detection module is configured to detect a remaining power of the electric energy storage component, the connection status detection module is configured to detect a connection status of the electric energy transmitting component and the electronic device to be charged, the charging time detection module is configured to detect the time required for the electronic device to be charged to complete charging;

the detection component is connected with the wireless transmission component and is configured to transmit information detected by the detection component to the electronic device to be charged.

According to an aspect of the present application, the battery case is further provided with a fixing assembly, the fixing assembly is configured to fix the battery body and the electronic device to be charged.

According to an aspect of the present application, the fixing assembly includes at least one magnetic member, which is fastened to a surface of the battery case adjacent to the electric energy transmitting component.

According to an aspect of the present application, the fixing assembly includes two magnetic members that are fastened to the surface of the battery case adjacent to the electric energy transmitting component and are arranged respectively at opposite ends of the surface.

According to an aspect of the present application, the electric energy storage component includes a battery cell, the electric energy transmitting component includes a transmitting coil which generates an oscillating magnetic field upon being energized, the electric energy receiving component includes a receiving coil, wherein the transmitting coil is connected with the battery cell, the receiving coil is connected with the battery cell, and the receiving coil generates an alternating current in the oscillating magnetic field.

According to an aspect of the present application, the battery case includes an upper case and a lower case, the upper case is configured to cover the lower case, and a space for accommodating the battery assembly is defined between the upper case and the lower case.

According to an aspect of the present application, a power control component is further arranged inside the battery case, the power control component is connected with the electric energy storage component, and is configured to activate or deactivate the connection between the electric energy storage component and the electric energy transmitting component.

Compared with the prior art, the electricity storage device provided by the present application has the following beneficial effects: by setting the electric energy transmitting component, the electricity storage device could be configured to connect with the electronic device to be charged without a cable, and directly transmits the electric energy into the electronic device for charging, which can avoid the problem that the user needs to carry a charging cable, and can also solve the problem that different electronic devices need to carry different charging cables, thereby allowing the users to conveniently use it; by setting the electric energy receiving component, the electricity storage device itself can be charged without the connection with a power through a cable, and similarly avoids the problem of looking for a charging cable when the electricity storage device itself need to be charged; by setting the power adaptation component to connect with the electric energy receiving component, an alternating current received by the electric energy receiving component can be converted into an direct current and inputted into the electric energy storage component to conveniently store the electric energy; by setting the wireless transmission component and data storage component, the electronic device can transfer and save files into the data storage component in the battery case, the files can be obtained from the data storage component when it expects to use or check the files; thus, the storage space of the electronic device is saved, and it is also convenient to inquire the files.

### BRIEF DESCRIPTION OF THE DRAWINGS

In order to make the technical solutions in the embodiments of the present application clearer, the accompanying drawings to be used in the embodiments and the description of the prior art will be briefly introduced below, it is apparent that the drawings in the following description are merely some embodiments of the present application and that other drawings can be obtained by those skilled in the field without departing from the inventive nature of the application.

FIG. 1 is a perspective structural view of an electricity storage device according to one embodiment of the present application;

FIG. 2 is an exploded perspective structural view of an electricity storage device according to one embodiment of the present application.

The drawings are marked accordingly as follows:

| | |
|---|---|
| 1 - battery case | 4 - electric energy receiving |
| | component |
| 7 - battery detection component | 2 - electric energy storage |
| | component |
| 5 - power adaptation component | 71 - power indicator light |
| 3 - electric energy transmitting | 6 - fixing assembly |
| component | |
| 8 - power control component | 11 - upper case |
| 12 - lower case | 13 - detection component |
| 9 - wireless transmission component | 10 - data storage component |

### DETAILED DESCRIPTION OF THE EMBODIMENTS

In order to make the objects, technical solutions, and beneficial effects of the present application clearer and more understandable, the present application will be further described in detail hereinafter with reference to the accompanying drawings and embodiments. It should be understood that the embodiments described herein are only intended to illustrate but not to limit the present application.

It is noted that when a component is referred to as being “fastened to” or “disposed on” another component, it can be directly or indirectly on the other component. When a component is referred to as being “connected to” another component, it can be directly or indirectly connected to the other component.

It should also be noted that the same or similar reference numbers in the drawings according to the embodiments of the present application refer to the same or similar components. In the description of the present application, it should be understood that, if the terms “upper”, “lower”, “left” and “right” and other terms indicating the orientation or positional relationship are based on orientation or positional relationship shown in the drawings, only for the purpose of facilitating the description of the application and simplifying the description, instead of indicating or implying that the indicated device or component must have a specific orientation and constructed and operated in a particular orientation, and therefore the terms used to describe the positional relationship shown in the drawings are only for illustration and are not intended to limit the present application. The specific meaning of the above terms could be understood by those ordinary skilled in the field according to specific circumstances.

In addition, the terms “first” and “second” are for illustrative purposes only and should not be construed as indicating or implying a relative importance or implicitly indicating the quantity of technical features indicated. Therefore, a feature that defines “first” and “second” may expressly or implicitly include one or more of the features. In the description of the present application, “multiple” means two or more than two, unless otherwise specifically defined.

In order to illustrate the technical solutions described in the present application, an implementation of an electricity storage device provided by the present application is described in detail below with reference to specific drawings by using specific embodiments.

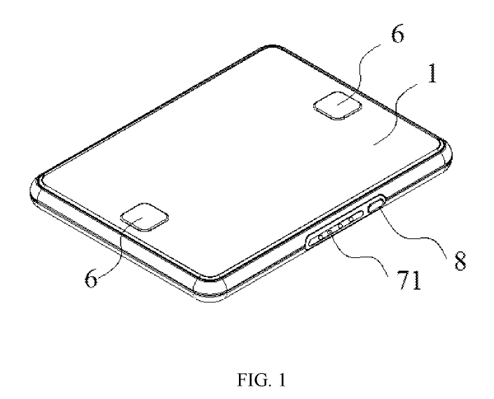

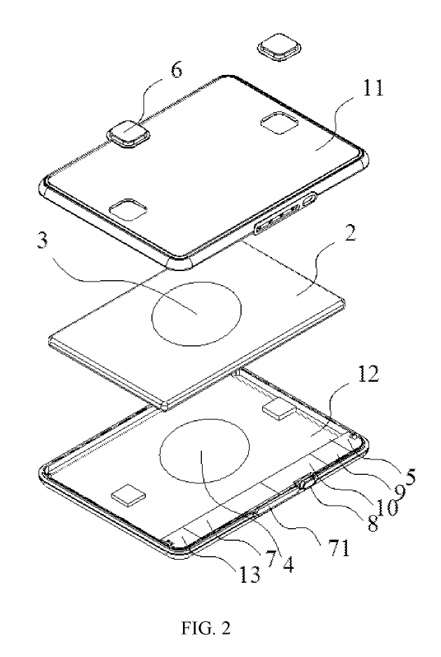

As shown in FIG. 1 and FIG. 2, an electricity storage device according to one embodiment of the present application includes a battery case 11, the battery case 11 includes a upper case 11 and a lower case 12, the upper case 11 is configured to cover the lower case 12, and a space for accommodating the battery assembly is defined between the upper case 11 and the lower case 12, the material of the upper case 11 is plastic or toughened glass. In another embodiment, the battery case 1 includes a upper case 11, a battery frame and a lower case 12, the upper case 11 is disposed on the an upper side of the battery frame, and the lower case 12 is disposed on the lower side of the battery frame, the upper case 11, the battery frame and the lower case 12 define a space for accommodating the battery internal components. The material of the upper case 11 and the lower case 12 is plastic or toughened glass, etc. The material of the battery frame is metal or plastic, etc. The battery case 1 is provide with an electric energy storage component 2, an electric energy transmitting component 3, an electric energy receiving component 4 and a power adaptation component 5 therein. The electric energy storage component 2 is connected with the electric energy receiving component 4 and wirelessly receives external electric energy through the electric energy receiving component 4 and stores the electric energy; the power adaptation component 5 is connected with the electric energy receiving component 4 and configured to convert the alternating current through the electric energy receiving component 4 into a direct current and to store the current in the electric energy storage component 2; the electric energy transmitting component 3 is connected with the electric energy storage component 2 and wirelessly transmits the electric energy stored in the electric energy storage component 2 to an electronic device to be charged; the battery case is further provided therein a wireless transmission component 9 and a data storage component 10, wherein the wireless transmission component 9 is connected with the electric energy storage component which provides electricity for the wireless transmission component 9, the wireless transmission component 9 is configured to be connected with the data storage component 10 and to input wirelessly received data into the data storage component 10 and to wirelessly output the data stored by the data storage component 10 to the electronic device.

The electricity storage device in the present embodiment has the following technical effects:

By setting the electric energy transmitting component 3, the electricity storage device could be configured to connect with the electronic device to be charged without a cable, and directly transmits the electric energy into the electronic device for charging, which can avoid the problem that the user needs to carry a charging cable, and can also solve the problem that different electronic devices need to carry different charging cables, thereby allowing the users to conveniently use it; by setting the electric energy receiving component 4, the electricity storage device itself can be charged without the connection with a power through a cable, and similarly avoids the problem of looking for a charging cable when the electricity storage device itself need to be charged; by setting the power adaptation component 5 to connect with the electric energy receiving component 4, an alternating current received by the electric energy receiving component 4 can be converted into an direct current and inputted into the electric energy storage component 2 to conveniently store the electric energy; by setting the wireless transmission component 9 and data storage component 10, an electronic device can transfer and save files into the data storage component 10 in the battery case 1, the files can be obtained from the data storage component 10 when it expects to use or check the files; thus, the storage space of the electronic device is saved, and it is also convenient to inquire the files.

According to an aspect of the present application, the wireless transmission component 9 is a Wi-Fi component, and the electricity storage device, which supports wireless charging and wireless discharge, is connected to the same Wi-Fi network as the electronic device. The electricity storage device, which supports wireless charging and wireless discharge, can wirelessly receive data of the electronic device through the Wi-Fi component and transmit the data to the data storage component 10 and wirelessly output the data stored in the data storage component 10 to the electronic device.

According to an aspect of the present application, the wireless transmission component 9 is a Bluetooth component, the electricity storage device can wirelessly receive data of the electronic device through the Bluetooth component and transmit the data to the data storage component 10, and wirelessly output the data stored in the data storage component 10 to the electronic device.

According to an aspect of the present application, a detection component 13 is further arranged inside the battery case 1, the detection component 13 is connected respectively with the electric energy storage component 2 and the electric energy transmitting component 3, and the detection component 13 comprises a power detection module, a connection state detection module and a charging time detection module, the power detection module is configured to detect a remaining power of the electric energy storage component 2, the connection status detection module is configured to detect a connection status of the electric energy transmitting component 3 and the electronic device to be charged, the charging time detection module is configured to detect the time required for the electronic device to be charged to complete charging; the detection component 13 is connected with the wireless transmission component 9 and is configured to transmit information detected by the detection component 13 to the electronic device to be charged and displayed on the display device of the electronic device. By setting the detection component 13 and the wireless transmission component 9, the electricity storage device is configured to detect the remaining capacity, the connection status, and the completion of the charging time of the electric energy storage component 2, and transmits the information to the electronic device for display, the user can obtain more information about charging through the display device on the electronic device, which improves the user experience.

According to an aspect of the present application, the battery case 1 is further provided with a fixing assembly 6 configured to fix the electronic device to be charged, the fixing assembly 6 includes a magnetic member, the magnetic member is fastened to a surface of the battery 1. Specifically, the magnetic member is disposed in the upper case 11 for attracting a metal case on the electronic device or a protective case with a metal sheet fitted on the electronic device. The electricity storage device is fastened on the electronic device, and both are fastened by means of magnetic attraction so as to be easily installed or disassembled. By setting the fixing assembly 6, the electricity storage device can be fastened on the electronic device to be charged, so as to limit the distance between the electricity storage device and the electricity storage device and prevent the electricity storage device from being far away from each other, and when the electricity storage device and the electronic device is fastened to each other, the electricity storage device is hard to fall off from the electronic device and fail to be charged.

According to an aspect of the present application, the fixing assembly 6 includes at least one magnetic member, and the at least one magnetic member is fastened to a surface of the battery case 1 adjacent to the electric energy transmitting component 3.

According to an aspect of the present application, the fixing assembly 6 includes two magnetic members that are fastened to the surface of the battery case 1 adjacent to the electric energy transmitting component 3 and are arranged respectively at opposite ends of the surface. The two oppositely disposed magnetic parts are attracted to two corresponding metal sheets sleeved on the electronic device, so that the positioning of the electric energy transmitting component 3 and the receiving component disposed inside the electronic device is more accurate and the coupling therebetween is more efficient, which can reduce the loss of the electric energy in the transmission process.

In another embodiment, the fixing assembly 6 can further include a plurality of magnetic members, the plurality of magnetic members being evenly distributed adjacent to the edge of the surface of the battery case 1 adjacent to the electric energy transmitting component 3.

According to an aspect of the present application, the fixing assembly 6 includes a clamping member disposed on a surface of the battery case 1, and the clamping member is clamped at one end of the electronic device. The electricity storage device can be fastened on the electronic device to be charged by setting the clamping member, which is easy to install or disassemble.

According to an aspect of the present application, the electric energy storage component includes a battery cell, which is a cell that supports charging and discharging, such as a lithium battery cell, a graphene battery cell, or a polymer battery cell. The electric energy transmitting component includes a transmitting coil which generates an oscillating magnetic field upon being energized, the electric energy receiving component comprises a receiving coil, wherein the transmitting coil is connected with the battery cell, the receiving coil is connected with the battery cell, and the receiving coil generates an alternating current in the oscillating magnetic field. The transmitting coil and the receiving coil realize electric energy transmission through the principle of electromagnetic induction.

According to an aspect of the present application, a power control component 8 is further arranged inside the battery case 1, the power control component 8 is connected with the electric energy storage component 2, and is configured to activate or deactivate the connection of the electric energy storage component 2 and the electric energy transmitting component 3. Specifically, the power control component 8 is a switch button. The manner of the switch can be that, the push switch is first pressed to be activated, then the switch is pressed again to be deactivated. In order to prevent wrong touch, it is an alternative way to set the switch button to be activated upon long press, and to be deactivated upon short press twice; or, other ways to prevent wrong touch are also anticipated.

The aforementioned embodiments are only preferred embodiments of the present application, and are not intended for limiting the present application. Any modification, equivalent replacement, improvement, and so on, which are made within the spirit and the principle of the present application, should be included in the protection scope of the present application.

1. An electricity storage device comprising a battery case in which an electric energy storage component, an electric energy transmitting component, an electric energy receiving component and a power adaptation component are arranged, wherein
the electric energy storage component is connected with the electric energy receiving component and wirelessly receives external electric energy through the electric energy receiving component and stores the electric energy, the power adaptation component is connected with the electric energy receiving component and configured to convert an alternating current through the electric energy receiving component into a direct current and to store the converted current in the electric energy storage component, electric energy transmitting component is connected with the electric energy storage component and configured to wirelessly transmit the electric energy stored in the electric energy storage component to an electronic device to be charged, and
the battery case is further provided therein a wireless transmission component and a data storage component, the wireless transmission component being connected with the electric energy storage component which provides electricity for the wireless transmission component, the wireless transmission component being configured to be connected with the data storage component and to input wirelessly received data into the data storage component and to wirelessly output the data stored by the data storage component to the electronic device.

2. The electricity storage device of claim 1, wherein the wireless transmission component is a Wi-Fi component, the electricity storage device can wirelessly receive data of the electronic device through the Wi-Fi component and transmit the data to the data storage component, and wirelessly output the data stored in the data storage component to the electronic device.

3. The electricity storage device of claim 1, wherein the wireless transmission component is a Bluetooth component, the electricity storage device can wirelessly receive data of the electronic device through the Bluetooth component and transmit the data to the data storage component, and wirelessly output the data stored in the data storage component to the electronic device.

4. The electricity storage device of claim 1, further comprising a detection component arranged in the battery case, wherein
the detection component is connected respectively with the electric energy storage component and the electric energy transmitting component,
the detection component comprises a power detection module, a connection state detection module and a charging time detection module, the power detection module being configured to detect remaining power of the electric energy storage component, the connection status detection module being configured to detect a connection status of the electric energy transmitting component and the electronic device to be charged, the charging time detection module being configured to detect the time required for the electronic device to complete charging; and
the detection component is connected with the wireless transmission component and is configured to transmit information detected by the detection component to the electronic device.

5. The electricity storage device of claim 1, wherein the battery case is further provided with a fixing assembly configured to fix a battery body and the electronic device to be charged.

6. The electricity storage device of claim 5, wherein the fixing assembly comprises at least one magnetic member fastened to a surface of the battery case adjacent to the electric energy transmitting component.

7. The electricity storage device of claim 6, wherein the fixing assembly comprises two magnetic members that are fastened to the surface of the battery case adjacent to the electric energy transmitting component, and are arranged respectively at opposite ends of the surface.

8. The electricity storage device of claim 1, wherein the electric energy storage component comprises a battery cell, the electric energy transmitting component comprises a transmitting coil which generates an oscillating magnetic field upon being energized, and the electric energy receiving component comprises a receiving coil, the transmitting coil being connected with the battery cell, the receiving coil being connected with the battery cell, and the receiving coil generating an alternating current in the oscillating magnetic field.

9. The electricity storage device of claim 1, wherein the battery case comprises an upper case and a lower case, the upper case being configured to cover the lower case, and a space for accommodating a battery assembly is defined between the upper case and the lower case.

10. The electricity storage device of claim 1, wherein a power control component is further arranged inside the battery case, the power control component being connected with the electric energy storage component, and being configured to activate or deactivate the connection between the electric energy storage component and the electric energy transmitting component.
